(19) United States
(12) Patent Application Publication
(10) Pub. No.: US 2026/0187825 A1
(43) Pub. Date: Jul. 2, 2026

(54) Method For Performing Image Registration

(71) Applicant: Sanofi, PARIS (FR)

(72) Inventors: Qi Tang, Cambridge, MA (US); Roger Trullo, Paris (FR)

(21) Appl. No.: 19/128,477

(22) PCT Filed: Nov. 8, 2023
(86) PCT No.: PCT/EP2023/081106

§ 371 Date: May 8, 2025

(30) Foreign Application Priority Data
Nov. 10, 2022 (EP) 22315272.9

(51) Int. Cl. G06T 7/37; G06T 7/32

(52) U.S. Cl. CPC G06T 7/37; G06T 7/32; G06T 2207/30024

(57) ABSTRACT

A computer-implemented method for performing image registration of a plurality of images of a subject, the method comprising: receiving a first image of a subject and a second image of the subject; performing a first image registration to register the first image and the second image; receiving parameters of a bounding shape identifying a region of interest of the registered first image or the registered second image; generating a first cropped image of the registered first image and a second cropped image of the registered second image based on the parameters of the bounding shape; and performing a second image registration to register the first cropped image and the second cropped image.

### CROSS REFERENCE TO RELATED APPLICATIONS

The present application is the national stage entry of International Patent Application No. PCT/EP2023/081106, filed on Nov. 8, 2023, and claims priority to Application No. EP 22315272.9, filed on Nov. 10, 2022, the disclosures of which are incorporated herein by reference.

### TECHNICAL FIELD

This specification relates to methods and systems for performing image registration of a plurality of images of a subject. The methods and systems may be used to register medical images, such as images of consecutive slices of a tissue sample obtained from an animal subject. However, the methods and systems may also be used to register other types of images of a subject.

### BACKGROUND

Image registration may be used to overlay two or more images of the same subject taken at different times, from different viewpoints, and/or by different sensors. In the field of medical imaging, multiple images may be generated from a tissue sample of a subject such as a human in order to gain complimentary information regarding biological or medical insights about the subject. For example, a first image may be an immunohistochemistry (IHC) image of a first slice of the tissue sample while a second image may be an IHC image of a second slice of the tissue sample. In some cases the second slice may be consecutive to the first slice (i.e. the second slice was parallel and adjacent to the first slice in the tissue sample). The first image may be a CD8 (cluster of differentiation 8) stained IHC image while the second IHC image may be a pan-cytokeratin (Pan-CK) stained IHC image, for example. CD8 IHC images and Pan-CK IHC images may be used for the classification of patients into predefined immune phenotypes.

### SUMMARY

To facilitate analysis of images, they may need to be matched pixel-to-pixel through a process of image registration. Image registration may allow for a number of image analysis techniques to subsequently be performed using the registered images including, but not limited to, virtual staining, semantic image segmentation, cancer immune phenotyping, or the creation of patient models for a simulation.

At present, a human expert such as a pathologist can analyse the first and second images and attempt to manually perform registration of those images, however this can be a very time-consuming process and requires a high level of skill. Known computer-implemented registration methods may instead be used, however they can result in poor image alignment. Images which represent the same subject but which are captured by different imaging modalities or differ on a local level may be misaligned by existing image registration methods. For example, existing image registration methods do not work well for IHC images from consecutive slices of tumour biopsy samples.

There is therefore a need to provide an improved method of performing image registration of a plurality of images of a subject which may be less time consuming and may provide improved alignment.

According to a first aspect of this disclosure, there is provided a computer-implemented method for performing image registration of a plurality of images of a subject, the method comprising: receiving a first image of a subject and a second image of the subject; performing a first image registration to register the first image and the second image; receiving parameters of a bounding shape identifying a region of interest of the registered first image or the registered second image; generating a first cropped image of the registered first image and a second cropped image of the registered second image based on the parameters of the bounding shape; and performing a second image registration to register the first cropped image and the second cropped image. Performing the first image registration may comprise: segmenting the first image to generate a first segmented image and segmenting the second image to generate a second segmented image; generating a first distance map based on the first segmented image and generating a second distance map based on the second segmented image; registering the first distance map and the second distance map; and registering the first image and the second image based on the registration of the first distance map and the second distance map.

The first segmented image and the second segmented image may be binary images.

The first image registration may comprise a rigid transformation.

Performing the second image registration may comprise performing a normalised cross correlation based on the first cropped image and the second cropped image.

Performing the second image registration may further comprise using a Fast Fourier Transform (FFT) to transform the first cropped image and second cropped image from the spatial domain to the frequency domain, wherein the normalised cross correlation may be performed using the first cropped image in the frequency domain and the second cropped image in the frequency domain.

The subject may be an organism and the plurality of images may be a plurality of images of a tissue of the organism.

The first image may be an image of a first slice of the tissue of the organism and the second image may be an image of a second slice of the tissue of the organism.

The first image registration may be performed based on tissue-level morphology of the first image and the second image.

The second image registration may be performed based on cell-level morphology of the first cropped image and the second cropped image.

At least one of the first image or the second image may be an immunohistochemistry image or a hematoxylin and eosin stain image.

At least one of: the first cropped image may have a higher image resolution than the first image; or the second cropped image may have a higher image resolution than the second image.

The method may further comprise outputting for display the registered first cropped image and second cropped image.

According to a second aspect of this disclosure, there is provided a computer-implemented method for performing image registration of a plurality of images of a subject, the method comprising: receiving a first image of a subject and a second image of the subject; and performing a first image registration to register the first image and the second image; wherein performing the first image registration may comprise: segmenting the first image to generate a first segmented image and segmenting the second image to generate a second segmented image; generating a first distance map based on the first segmented image and generating a second distance map based on the second segmented image; registering the first distance map and the second distance map; and registering the first image and the second image based on the registration of the first distance map and the second distance map.

The method may further comprise receiving parameters of a bounding shape identifying a region of interest of the registered first image or the registered second image; generating a first cropped image of the registered first image and a second cropped image of the registered second image based on the parameters of the bounding shape; and performing a second image registration to register the first cropped image and the second cropped image.

The first segmented image and the second segmented image may be binary images.

The first image registration may comprise a rigid transformation.

Performing the second image registration may comprise performing a normalised cross correlation based on the first cropped image and the second cropped image.

Performing the second image registration may further comprise using a Fast Fourier Transform (FFT) to transform the first cropped image and second cropped image from the spatial domain to the frequency domain, wherein the normalised cross correlation may be performed using the first cropped image in the frequency domain and the second cropped image in the frequency domain.

The subject may be an organism and the plurality of images may be a plurality of images of a tissue of the organism.

The first image may be an image of a first slice of the tissue of the organism and the second image may be an image of a second slice of the tissue of the organism.

The first image registration may be performed based on tissue-level morphology of the first image and the second image.

The second image registration may be performed based on cell-level morphology of the first cropped image and the second cropped image.

At least one of the first image or the second image may be an immunohistochemistry image or a hematoxylin and eosin stain image.

At least one of: the first cropped image may have a higher image resolution than the first image; or the second cropped image may have a higher image resolution than the second image.

The method may further comprise outputting for display the registered first cropped image and second cropped image.

According to a third aspect of the present disclosure, there is provided a computer program product comprising computer-readable code that, when executed by a computing system, causes the computing system to perform a method according to any preceding method.

According to a fourth aspect of the present disclosure, there is provided system comprising one or more processors and a memory, the memory storing computer readable instructions that, when executed by the one or more processors, causes the system to perform any preceding method.

### BRIEF DESCRIPTION OF THE FIGURES

Embodiments will now be described by way of non-limiting examples with reference to the accompanying drawings, in which:

FIG. 1 shows a schematic overview of an example known method for performing image registration;

FIG. 2 shows images extracted from the images of FIG. 1;

FIG. 3 shows a schematic overview of an example method for performing image registration of a plurality of images of a subject according to aspects of the present disclosure;

FIG. 4 shows a flowchart of an example method of performing image registration of a plurality of images of a subject according to aspects of the present disclosure;

FIG. 5 shows a flowchart of another example method of performing image registration of a plurality of images of a subject according to aspects of the present disclosure; and

FIG. 6 shows a schematic example of a system/apparatus for performing any of the methods described herein.

### DETAILED DESCRIPTION

As discussed, known computer-implemented registration methods may result in poor image alignment, particularly of medical images obtained from a tissue sample. For example, existing registration methods do not work well for IHC images from consecutive slices of tumour biopsy samples.

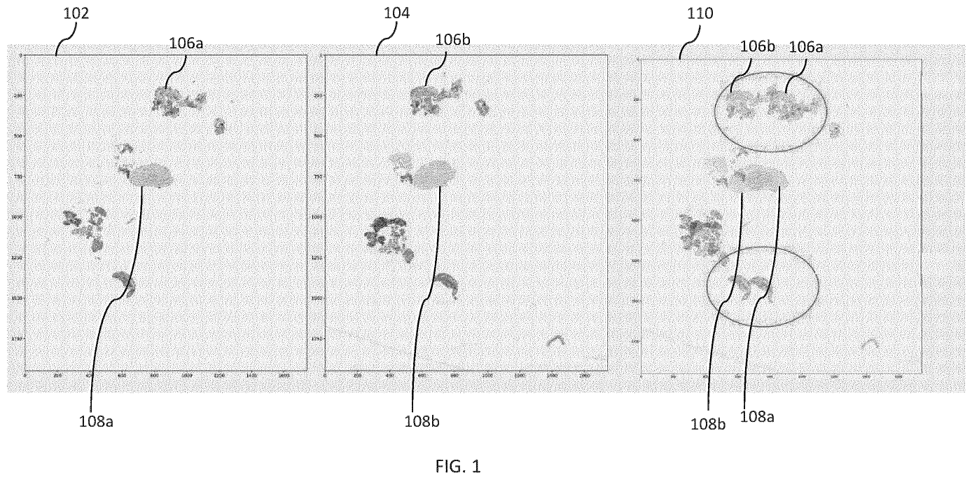

FIG. 1 shows a schematic overview of an example known method for performing image registration. FIG. 1 shows a first IHC image 102 and a second IHC image 104 prior to registration of the images by the known registration method. The first IHC image 102 in this example is a CD8 stained IHC image while the second IHC image 104 is a Pan-CK stained IHC image.

The first IHC image 102 and second IHC image 104 are of consecutive slices of a tumour biopsy sample. The first IHC image 102 in this example includes at least an image representation of a first tissue structure 106a and an image representation of a second tissue structure 108a. Being an image of a consecutive slice of a tumour biopsy sample, the second IHC image 104 in this example also contains image representations of the first and second tissue structures, however it can be seen in FIG. 1 that the image representation of the first tissue structure 106b and the image representation of the second tissue structure 108b in the second IHC image 104 both differ visually from the corresponding image representation of the first tissue structure 106a and image representation of the second tissue structure 108a in the first IHC image 102. For example, the image representation of the first tissue structure 106b and the image representation of the second tissue structure 108b as shown in the second IHC image 104 are in different locations relative to the image representation of the first tissue structure 106a and the image representation of the second tissue structure 108a in the first IHC image 102. Furthermore, while the tissue structures of the first IHC image 102 and second image 104 may appear similar on a global, tissue-level scale, the similarities may be less visible on a local (e.g. cell-level) scale.

The image representation of the first tissue structure 106a and image representation of the second tissue structure 108a in the first IHC image 102 may differ from the image representation of the first tissue structure 106b and image representation of the second tissue structure 108b in the second IHC image 104 for a number of different reasons. For example, the use of different staining techniques (CD8 versus Pan-CK) to generate the first IHC image 102 and second IHC image 104 may account for some of the differences. Furthermore, where the first IHC image 102 and the second IHC image 104 are obtained from different slices of the same tissue sample, each slice will be similar to the previous or next consecutive slice but not identical, due to each slice containing different cells.

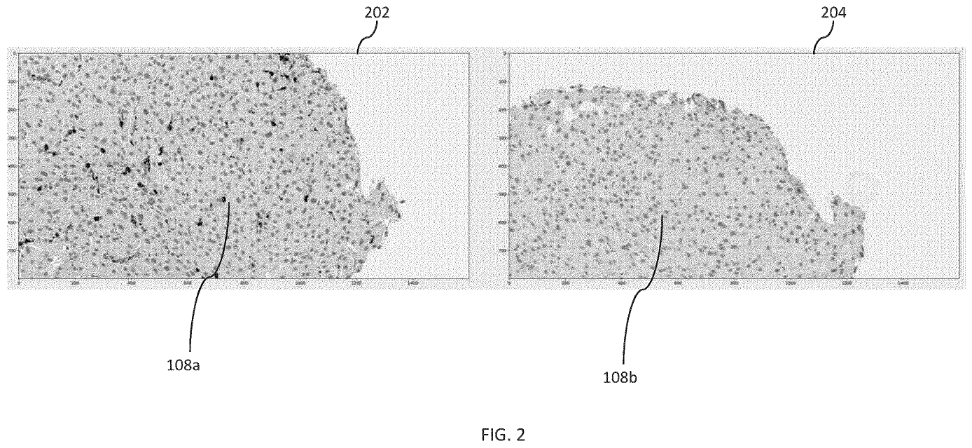

Consecutive slices may therefore have very similar morphology on the tissue level, but their morphology may be less similar on the cellular level. This is illustrated by FIG. 2, which shows a first zoomed portion 202 of the first IHC image 102 and a second zoomed portion 204 of the second IHC image 104. The first zoomed portion 202 contains part of the image representation of the second tissue structure 108a obtained from the first IHC image 102 while the second zoomed portion 204 contains part of the image representation of the second tissue structure 108b obtained from the second IHC image 104. While the first zoomed portion 202 and second zoomed portion 204 appear similar at a global level (e.g. have similar outlines of the tissue structure), it can be seen on closer inspection that they differ at the cellular level (indicted by the dots in the first zoomed potion 202 and second zoomed portion 204). This may be due to different cell counts and cell morphology between the slice of tissue sample used for the first IHC image 102 and the slice of tissue used for the second IHC image 104.

Known computer-implemented image registration methods for registering the first IHC image 102 and the second IHC image 104 may produce a sub-optimal registration, as illustrated by the composite IHC image 110 shown in FIG. 1. Composite IHC image 110 has been generated after registering the first IHC image 102 and the second IHC image 104 using a known image registration method. The composite IHC image 110 may have been generated by overlaying the first IHC image 102 and second IHC image 104 after they have been aligned using the known image registration method.

The composite IHC image 110 shows the image representations 106a, 106b, 108a, 108b of the first tissue structure and second tissue structure discussed previously in relation to the first IHC image 103 and the second IHC image 104. However, it can be seen from the composite IHC image 110 that the image representations 106a, 106b, 108a, 108b of the first tissue structure and second tissue structure are poorly aligned, and therefore that the first IHC image 102 and second IHC image 104 as a whole as a whole are poorly aligned. This poor alignment may be due to the known registration method not being able to successfully handle the differences between the first IHC image 102 and the second IHC image 104 on the cellular level. Such poor alignment can make analysis of the composite IHC image 110 by a medical professional difficult. While FIG. 1 has been discussed in relation to IHC images, the discussion may equally apply to other types of medical image, or indeed types of non-medical image. For example, at least one of the first IHC image 102 or the second IHC image 104 may be a different type of IHC image, or be a hematoxylin and eosin (H&E) stained image rather than an IHC image. In other examples, one of the images may be an image obtained by magnetic resonance imaging (MRI) while the other image may be obtained from a computed tomography (CT) scan.

Aspects of the present disclosure may provide an improved method of image registration. Aspects of the present disclosure may be of particular relevance for registering a plurality of images that have greater similarity on a global scale than they do on a local scale.

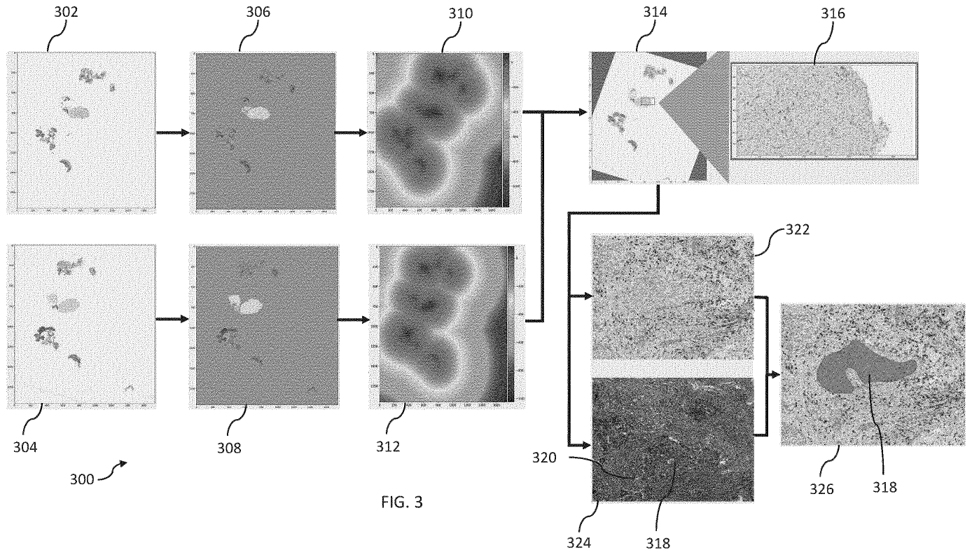

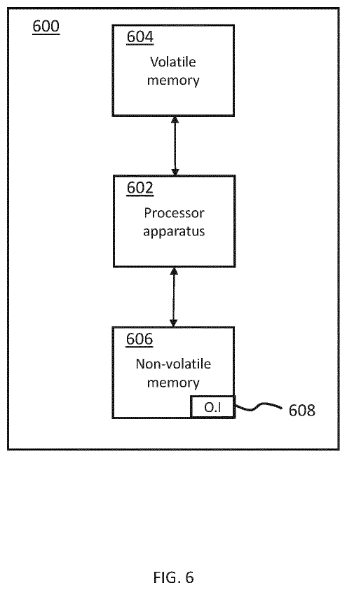

FIG. 3 shows a schematic overview of a computer-implemented method 300 for performing image registration of a plurality of images of a subject according to aspects of the present specification. The method 300 may be performed by a computing system, such as the system described in relation to FIG. 6.

A first image 302 of a subject and a second image 304 of a subject are received. The first image 302 and the second image 304 shown in FIG. 3 are identical to the first IHC image 102 and the second IHC image 104 discussed in relation to FIG. 1, however in other examples different types of images may be received such as H&E stain images.

In this example, the subject is a human patient and the first image 302 and second image 304 are images of consecutive slices of a tumour biopsy sample taken from the patient. The first image 302 and second image 304 contain corresponding features such as tissue structures that are to be analysed after the images have been registered. However, the techniques described herein are applicable in many other scenarios and in a wide range of organisms, such as plants, animals, fungus, bacteria and viruses.

A first image registration process is performed using the first image 302 and the second image 304 to register (i.e. align) the first image 302 and the second image 304. Image registration may be used to estimate a transform between the first image 302 and the second image 304. The estimated transform may be applied to the first image 302 or the second image 304 to align each image.

The first image registration is a global registration and aligns the first image 302 and the second image 304 based on tissue-level morphology of the first image 302 and the second image 304. The first image registration may be performed using any suitable image registration method disclosed in Barbara Zitová, Jan Flusser, Image registration methods: a survey, Image and Vision Computing, Volume 21, Issue 11, 2003, Pages 977-1000, ISSN 0262-8856, https://doi.org/10.1016/S0262-8856(03)00137-9, for example.

In the example of FIG. 3, performing the first image registration comprises segmenting the first image 302 to generate a first segmented image 306 and segmenting the second image 304 to generate a second segmented image 308. The segmentation may be performed using a suitable thresholding segmentation algorithm known in the art, although other types of segmentation algorithm known in the art may be used instead. The segmentation may result in the creation of a binary image.

An example of a suitable segmentation algorithm is Otsu's algorithm, for example as disclosed at N. Otsu, “A Threshold Selection Method from Gray-Level Histograms,” in IEEE Transactions on Systems, Man, and Cybernetics, vol. 9, no. 1, pp. 62-66, Jan. 1979, doi: 10.1109/TSMC.1979.4310076 (https://ieeexplore.ieee.org/document/4310076).

Another example of a segmentation algorithm may use deep learning based methods, for example using a UNET convolutional neural network, for example as disclosed by Ronneberger, O., Fischer, P., Brox, T. (2015). U-Net: Convolutional Networks for Biomedical Image Segmentation. In: Navab, N., Hornegger, J., Wells, W., Frangi, A. (eds) Medical Image Computing and Computer-Assisted Intervention-MICCAI 2015. MICCAI 2015.

The first segmented image 306 (which may be a binary image) is then converted to a first distance map 310 and the second segmented image 308 (which may also be a binary image) is converted to a second distance map 312. A distance map is also known as a distance transform. The conversion to a distance map be performed using a suitable algorithm, for example as disclosed at C. R. Maurer, Jr., R. Qi, and V. Raghavan, “A Linear Time Algorithm for Computing Exact Euclidean Distance Transforms of Binary Images in Arbitrary Dimensions”, IEEE-Transactions on Pattern Analysis and Machine Intelligence, 25(2): 265-270, 2003.

The value of each pixel in the distance map 310, 312 corresponds to the distance to a closest contour point in the corresponding segmented image 306, 308. Binary images do not provide strong gradients, which is unhelpful for optimization when aligning the images during image registration. Distance map representation provides better gradient signals, and so can lead to improved optimization results when aligning the images.

The first image 302 can then be registered to the second image 304 by performing image registration on the first distance map 310 and second distance map 312 to obtain an estimated transform between the first distance map 310 and second distance map 312. The first image 302 can be registered to the second image 304 by applying the estimated transform.

The first image registration may comprise a rigid image registration involving a rigid transformation, that is a transformation by rotation and/or translation. Based on the assumption that the slices of tissue shown in the first image 302 and the second image 304 will be very similar morphologically on the tissue level, a rigid transformation should be sufficient for the first image registration. However, in other examples a different transformation such as an affine or non-rigid transformation could be used.

In this example, a gradient descent algorithm is used for the first image registration, which finds the best parameters given a rigid transformation, however in other examples the first image registration may be performed using any suitable algorithm known in the art. To use the gradient descent algorithm, we define a cost function which is the value that will be optimized. In this case we use the Mean Square Error as the cost function, but other metrics such as Mutual Information or L1 difference could be used in other examples.

FIG. 3 shows a composite image 314 generated from the registered first image 302 and second image 304. The composite image 314 may be generated by overlaying the first image 302 and second image 304 after they have been registered using the first image registration. Comparing the composite image 314 shown in FIG. 3 to the composite IHC image 110 shown in FIG. 1, it can be seen that the global registration method described so far may already provide improved image registration compared to previous methods of image registration, for example previous methods of image registration that do not involve segmenting the images and converting them into distance maps before performing registration.

Image 316 shows a portion of the composite image 314 generally corresponding to the second tissue structure previously discussed in relation to FIG. 1 and FIG. 2. It can be seen from image 316 that the first image 302 and second image 304 are already well-aligned.

It should be noted that in some examples, composite image 314 and/or image 316 are not actually generated. They are provided in FIG. 3 to illustrate the degree of alignment of the first image 302 and the second image 304 by the first image registration.

The first, global image registration may allow the first image 302 and second image 304 to be aligned to a sufficient accuracy. Nevertheless, in some examples further accuracy in the registration of the first image 302 and second image 304 may be achieved by also performing a second, local image registration, as discussed below.

Once the first image 302 and second image 304 have been aligned using the first registration, a region of interest (ROI) 318 is identified in at least one of the first image 302 or the second image 304, or in some examples the composite image 314. The ROI may be identified by a human user such as a pathologist, but in other examples it may be identified by a computer-implemented process, for example using a machine learning algorithm trained to identify a particular ROI. The ROI may contain a feature in the first image 302 and/or second image 304 that is of interest to a pathologist for further analysis.

Parameters of a bounding shape 320 identifying the ROI of the first image 302 or the second image 304 are received. The parameters may comprise coordinates of the bounding shape 320, for example coordinates corresponding to the position of the bounding shape in the first image 302 or second image 304. The parameters may have been determined based on an input provided by the user. For example, the user may draw the bounding shape 320 on a displayed version of the first image 302, second image 304 or composite image 314, using a user input interface such as a touchscreen or mouse coupled to the computing system described in relation to FIG. 6.

The parameters (such as co-ordinates) of the bounding shape 320 may be used to generate a pair of cropped images, in particular a first cropped image 322 of the first image 302 and a second cropped image 324 of the second image 304. More specifically, the parameters and the transform estimated by the first image registration process are used to identify the bounding shape 320 (and therefore ROI 318) in both the registered first image 302 and second image 304. For example, if the parameters relate to a bounding shape 320 identified at the first image 302, the corresponding bounding shape 320 may be determined for the second image 304 by applying the transform to the parameters. Similarly, if the parameters relate to a bounding shape 320 identified at the second image 304, the corresponding bounding shape 320 may be determined for the first image 302 by applying the transform to the parameters.

The first cropped image 322 may be cropped from the first image 302 based on the parameters so as to contain at least the ROI 318 identified by the bounding shape 320. The first cropped image 322 may be generated to include a margin around the bounding shape 320 so that the first cropped image 322 is larger than, and includes, the ROI 318 and bounding shape 320. For example, the first cropped image 322 may have a width and a height that are greater than the maximum width and height of the ROI 318 in the first image 302, in some examples by a predetermined amount.

In a similar manner to the first cropped image 322, the second cropped image 324 may be cropped from the second image 304 based on the parameters so as to contain at least the ROI 318 identified by the bounding shape 320. The second cropped image 324 may also be generated to include a margin around the bounding shape 320 so that the second cropped image 324 is larger than, and includes, the ROI 318 and bounding shape 320. For example, the second cropped image 324 may also have a width and a height that are greater than the maximum width and height of the ROI 318 in the second image 304, in some examples by a predetermined amount.

FIG. 3 shows the ROI 318 and bounding shape 320 located on the second cropped image 324.

A second, local image registration process is then performed to register the first cropped image 322 and the second cropped image 324. The second image registration may involve registering the first cropped image 322 and the second cropped image 324 on a smaller level than the first registration of the first image 302 to the second image 304. That is, the second image registration may involve registering the first cropped image 322 and the second cropped image 324 based on a cell-level morphology shown in the images rather than a tissue-level morphology in the images.

Performing the second image registration may comprise performing normalised cross-correlation (NCC) to register the first cropped image 322 and second cropped image 324. As an example, an NCC method as disclosed in D. Padfield, “Masked object registration in the Fourier domain” IEEE Transactions on Image Processing (2012). DOI:10.1109/TIP.2011.2181402 may be used, which is incorporated herein by reference. NCC is advantageous in that it is very fast to compute in the Fourier domain. However, in other examples the second image registration may be performed using a different suitable registration algorithm, for example an algorithm described in relation to the first image registration.

So that NCC may be performed, a Fast Fourier Transform (FFT) may be used to transform the first cropped image 322 and second cropped image 324 from a spatial domain to a frequency domain, with NCC then being performed on the transformed first cropped image 322 and second cropped image 324 in the frequency (Fourier) domain. A translation transformation to align the first cropped image 322 and second cropped image 324 may be determined based on the result of the NCC.

The translation transformation may then be used to register the first cropped image 322 and second cropped image 324. Additionally or alternatively, the translation transformation may be used to register the first image 302 and second image 304.

The registered first cropped image 322 and second cropped image 324, may be output for display, for example by a display coupled to the computing system described in relation to FIG. 6.

As shown in FIG. 3, a composite image 326 based on the registered first cropped image 322 and second cropped image 324 may be generated and output for display. The composite image 326 may comprise the registered first cropped image 322 overlayed with the registered second cropped image 324. FIG. 3 also shows the ROI 318 highlighted on the composite image 326, however this is optional.

In some implementations, the cropped images 322, 324 are resized/rescaled to a pre-determined size prior to performing the second image registration. Interpolation techniques may be used to perform the rescaling to fill in any missing pixel data.

The first cropped image 322 may have a higher resolution than the first image 302. For example, the first image 302 may be a relatively low resolution version of an image whereas the first cropped image 322 may be a cropped portion of a relatively high resolution version of the same image. Similarly, the second cropped image 324 may have a higher resolution than the second image 304. This may improve the efficiency of the overall image registration method, by performing the global registration on large, but relatively low resolution images, then performing the local registration on a relatively smaller, but higher resolution cropped images.

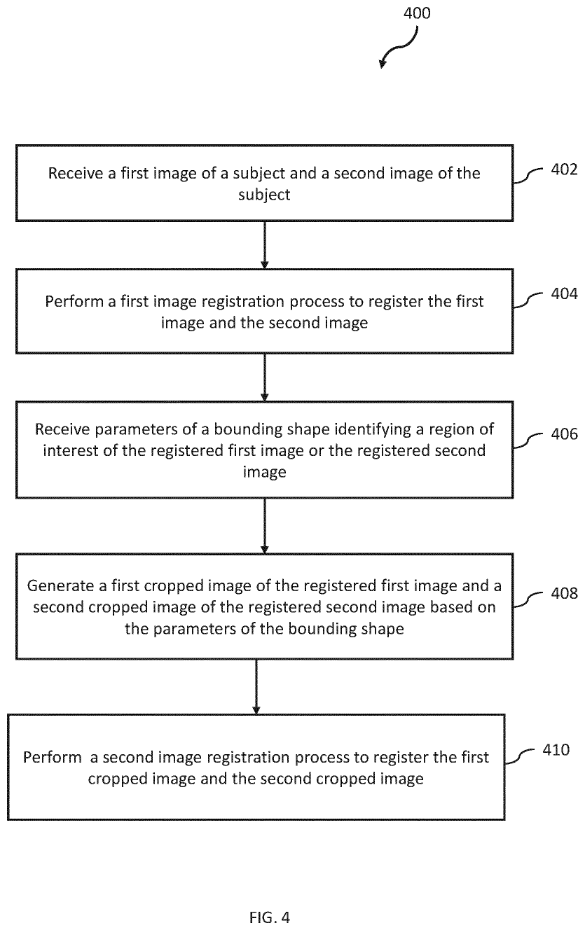

FIG. 4 shows a flowchart of an example method 400 for performing image registration of a plurality of images of a subject according to aspects of the present specification. The method 400 may be performed by a computing system, such as the system described in relation to FIG. 6. The method 400 may share one or more aspects with the method described previously in relation to FIG. 3.

At step 402 a first image 302 of a subject and a second image 304 of the subject are received. As an example, the subject may be an organism such as an animal, in particular a human. The first image 302 may be an image of a first slice of tissue of the organism and the second image 304 may be an image of a second slice of tissue. The first slice and second slice may be consecutive or near-consecutive slices of the same tissue. The first image 302 and the second image 304 may have been obtained using different methods of image preparation. For example, at least one of the first image 302 or the second image 304 may be an immunohistochemistry (IHC) image or a hematoxylin and eosin (H&E) stained image.

At step 404, a first image registration process to register the first image 302 and the second image 304 is performed. The first image registration may be a global registration and may be performed based on tissue-level morphology of the first image 302 and the second image 304. The first image registration may involve a rigid transform, although in other examples an affine or non-rigid transform may be used.

The first image registration may be performed using a gradient descent algorithm, with the mean square error selected as the cost function to optimize. However, in other examples a different cost function such as mutual information or L1 difference may be used, and/or a different algorithm to gradient descent may be used, as discussed previously.

At step 406, parameters of a bounding shape 320 identifying a region of interest 318 of the first image 302 or the second image 304 are received. The parameters may comprise co-ordinates, and may have been input by a user, for example by drawing the bounding shape 320 on a representation of the first image or second image output on a display.

At step 408, a first cropped image 322 of the first image 302 and a second cropped image 324 of the second image 304 are generated based on the parameters of the bounding shape 320. The first image 302 and second image 304 are both cropped to contain the ROI 318 identified by the bounding shape 320. The first image 302 and second image 304 have been registered using the first image registration process in step 404 and so the location of the bounding shape 320 in the first image 302 will have a correspondence to the location of the bounding shape 320 in the second image 304, based on the rigid transformation estimated during the first image registration. The parameters (e.g. coordinates) of the bounding shape 320 may therefore be applied to both the first image 302 and the second image 304 to produce the first cropped image 322 and second cropped image 324. This step limits the areas of the first image 302 and second image 304 subjected to the second image registration process. The first cropped image 322 and/or second cropped image 324 may be generated to include a margin around the bounding shape 320. The first cropped image 322 and/or second cropped image 324 may have a higher resolution than the corresponding first image 302 or second image 304.

At step 410, a second image registration process to register the first cropped image 322 and the second cropped image 324 is performed. The second image registration may involve registering the first cropped image 322 and the second cropped image 324 based on a cell-level morphology rather than a tissue-level morphology.

Performing the second image registration may comprise performing normalised cross-correlation (NCC) on the first cropped image 322 and second cropped image 324 to register the images, as discussed previously, although in other examples the second image registration may be performed using a different suitable registration algorithm.

Once the first cropped image 322 and the second cropped image 324 have been registered, the registered first cropped image 322 and second cropped image 324 may be output for display, for example on a computer display. A composite image 326 comprising the registered first cropped image 322 and second cropped image 324 (or at least portions of the registered first cropped image and second cropped image) may be output for display.

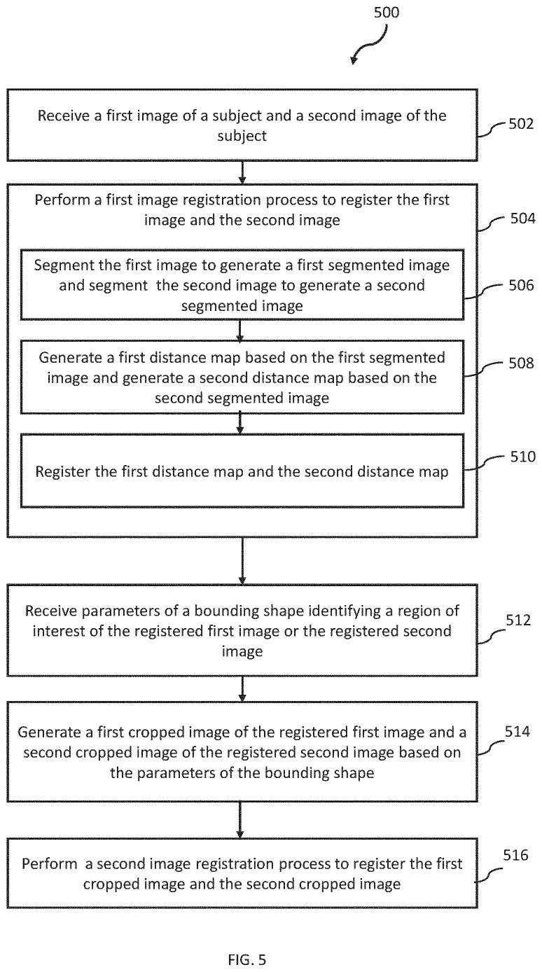

FIG. 5 shows a flowchart of another example method 500 for performing image registration of a plurality of images of a subject. The method 500 may be performed by a computing system, such as the system described in relation to FIG. 6. The method 500 illustrated in FIG. 5 is similar to the method illustrated in FIG. 5, but with additional steps.

At step 502, a first image 302 of a subject and a second image 304 of the subject are received, in some examples in a similar manner as previously described in relation to step 402 of FIG. 4.

At step 504, a first image registration process to register the first image 302 and the second image 304 is performed. This may be in a similar manner as previously described in relation to step 404 of FIG. 4, however step 504 comprises a number of additional steps 506, 508, 510.

At step 506, the first image 302 is segmented to generate a first segmented image 306 and the second image 304 is segmented to generate a second segmented image 308. This may be performed as previously described in relation to FIG. 3, for example.

At step 508, a first distance map 310 is generated based on the first segmented image 306 and a second distance map 312 is generated based on the second segmented image 308. This may be performed as previously described in relation to FIG. 3, for example.

At step 510, the first distance map 310 is registered to the second distance map 312. This may be performed using a registration algorithm, for example as previously discussed in relation to FIG. 3. The first image 302 and the second image 304 may then be registered based on the registration of the first distance map 310 and the second distance map 312. For example, a transform estimated from the registration of the first distance map 310 and the second distance map 312 may be applied to the first image 302 and/or the second image 304 to align the first image 302 and the second image 304.

At step 512, parameters of a bounding shape 320 identifying a region of interest 318 of the first image 302 or the second image 304 are received. Step 512 may correspond to one or more aspects of step 406 as discussed previously, and which shall not be repeated for brevity.

At step 514, a first cropped image 322 of the first image 302 and a second cropped image 324 of the second image 304 are generated based on the parameters of the bounding shape 320. Step 514 may correspond to one or more aspects of step 408 as discussed previously, and which shall not be repeated for brevity.

At step 516, a second image registration process to register the first cropped image 322 and the second cropped image 324 is performed. Step 516 may correspond to one or more aspects of step 410 as discussed previously, and which shall not be repeated for brevity.

Once the first cropped image 322 and the second cropped image 324 have been registered, the registered first cropped image 322 and second cropped image 324 may be output for display, for example on a computer display. A composite image 326 comprising the registered first cropped image 322 and second cropped image 324 (or at least portions of the registered first cropped image and second cropped image) may be output for display.

FIG. 6 shows a schematic example of a system/apparatus 600 for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 600 comprises one or more processors 602. The one or more processors control operation of other components of the system/apparatus 600. The one or more processors 602 may, for example, comprise a general-purpose processor. The one or more processors 602 may be a single core device or a multiple core device. The one or more processors 602 may comprise a Central Processing Unit (CPU) or a graphical processing unit (GPU). Alternatively, the one or more processors 702 may comprise specialised processing hardware, for instance a RISC processor or programmable hardware with embedded firmware. Multiple processors may be included.

The system/apparatus comprises a working or volatile memory 604. The one or more processors may access the volatile memory 704 in order to process data and may control the storage of data in memory. The volatile memory 604 may comprise RAM of any type, for example, Static RAM (SRAM), Dynamic RAM (DRAM), or it may comprise Flash memory, such as an SD-Card.

The system/apparatus comprises a non-volatile memory 606. The non-volatile memory 606 stores a set of operation instructions 608 for controlling the operation of the processors 602 in the form of computer readable instructions. The non-volatile memory 606 may be a memory of any kind such as a Read Only Memory (ROM), a Flash memory or a magnetic drive memory.

The one or more processors 602 are configured to execute operating instructions 608 to cause the system/apparatus to perform any of the methods described herein. The operating instructions 608 may comprise code (i.e. drivers) relating to the hardware components of the system/apparatus 600, as well as code relating to the basic operation of the system/apparatus 600. Generally speaking, the one or more processors 602 execute one or more instructions of the operating instructions 608, which are stored permanently or semi-permanently in the non-volatile memory 606, using the volatile memory 604 to store temporarily data generated during execution of said operating instructions 608.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 6, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the specification can be implemented and/or supplied and/or used independently.

Although several embodiments have been shown and described, it would be appreciated by those skilled in the art that changes may be made in these embodiments without departing from the principles of this disclosure, the scope of which is defined in the claims and their equivalents.

The terms “drug” or “medicament” are used synonymously herein and describe a pharmaceutical formulation containing one or more active pharmaceutical ingredients or pharmaceutically acceptable salts or solvates thereof, and optionally a pharmaceutically acceptable carrier. An active pharmaceutical ingredient (“API”), in the broadest terms, is a chemical structure that has a biological effect on humans or animals. In pharmacology, a drug or medicament is used in the treatment, cure, prevention, or diagnosis of disease or used to otherwise enhance physical or mental well-being. A drug or medicament may be used for a limited duration, or on a regular basis for chronic disorders.

As described below, a drug or medicament can include at least one API, or combinations thereof, in various types of formulations, for the treatment of one or more diseases. Examples of API may include small molecules having a molecular weight of 500 Da or less; polypeptides, peptides and proteins (e.g., hormones, growth factors, antibodies, antibody fragments, and enzymes); carbohydrates and polysaccharides; and nucleic acids, double or single stranded DNA (including naked and cDNA), RNA, antisense nucleic acids such as antisense DNA and RNA, small interfering RNA (siRNA), ribozymes, genes, and oligonucleotides. Nucleic acids may be incorporated into molecular delivery systems such as vectors, plasmids, or liposomes. Mixtures of one or more drugs are also contemplated.

The drug or medicament may be contained in a primary package or “drug container” adapted for use with a drug delivery device. The drug container may be, e.g., a cartridge, syringe, reservoir, or other solid or flexible vessel configured to provide a suitable chamber for storage (e.g., short-or long-term storage) of one or more drugs. For example, in some instances, the chamber may be designed to store a drug for at least one day (e.g., 1 to at least 30 days). In some instances, the chamber may be designed to store a drug for about 1 month to about 2 years. Storage may occur at room temperature (e.g., about 20° C.), or refrigerated temperatures (e.g., from about −4° C. to about 4° C.). In some instances, the drug container may be or may include a dual-chamber cartridge configured to store two or more components of the pharmaceutical formulation to-be-administered (e.g., an API and a diluent, or two different drugs) separately, one in each chamber. In such instances, the two chambers of the dual-chamber cartridge may be configured to allow mixing between the two or more components prior to and/or during dispensing into the human or animal body.

For example, the two chambers may be configured such that they are in fluid communication with each other (e.g., by way of a conduit between the two chambers) and allow mixing of the two components when desired by a user prior to dispensing. Alternatively or in addition, the two chambers may be configured to allow mixing as the components are being dispensed into the human or animal body.

The drugs or medicaments contained in the drug delivery devices as described herein can be used for the treatment and/or prophylaxis of many different types of medical disorders. Examples of disorders include, e.g., diabetes mellitus or complications associated with diabetes mellitus such as diabetic retinopathy, thromboembolism disorders such as deep vein or pulmonary thromboembolism. Further examples of disorders are acute coronary syndrome (ACS), angina, myocardial infarction, cancer, macular degeneration, inflammation, hay fever, atherosclerosis and/or rheumatoid arthritis. Examples of APIs and drugs are those as described in handbooks such as Rote Liste 2014, for example, without limitation, main groups 12 (anti-diabetic drugs) or 86 (oncology drugs), and Merck Index, 15th edition.

Examples of APIs for the treatment and/or prophylaxis of type 1 or type 2 diabetes mellitus or complications associated with type 1 or type 2 diabetes mellitus include an insulin, e.g., human insulin, or a human insulin analogue or derivative, a glucagon-like peptide (GLP-1), GLP-1 analogues or GLP-1 receptor agonists, or an analogue or derivative thereof, a dipeptidyl peptidase-4 (DPP4) inhibitor, or a pharmaceutically acceptable salt or solvate thereof, or any mixture thereof. As used herein, the terms “analogue” and “derivative” refers to a polypeptide which has a molecular structure which formally can be derived from the structure of a naturally occurring peptide, for example that of human insulin, by deleting and/or exchanging at least one amino acid residue occurring in the naturally occurring peptide and/or by adding at least one amino acid residue. The added and/or exchanged amino acid residue can either be codeable amino acid residues or other naturally occurring residues or purely synthetic amino acid residues. Insulin analogues are also referred to as “insulin receptor ligands”. In particular, the term “derivative” refers to a polypeptide which has a molecular structure which formally can be derived from the structure of a naturally occurring peptide, for example that of human insulin, in which one or more organic substituent (e.g. a fatty acid) is bound to one or more of the amino acids. Optionally, one or more amino acids occurring in the naturally occurring peptide may have been deleted and/or replaced by other amino acids, including non-codeable amino acids, or amino acids, including non-codeable, have been added to the naturally occurring peptide.

Examples of insulin analogues are Gly(A21), Arg(B31), Arg(B32) human insulin (insulin glargine); Lys(B3), Glu(B29) human insulin (insulin glulisine); Lys(B28), Pro(B29) human insulin (insulin lispro); Asp(B28) human insulin (insulin aspart); human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin. Examples of insulin derivatives are, for example, B29-N-myristoyl-des(B30) human insulin, Lys(B29) (N-tetradecanoyl)-des(B30) human insulin (insulin detemir, Levemir®); B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N-(N-palmitoyl-gamma-glutamyl)-des(B30) human insulin, B29-N-omega-carboxypentadecanoyl-gamma-L-glutamyl-des(B30) human insulin (insulin degludec, Tresiba®); B29-N-(N-lithocholyl-gamma-glutamyl)-des(B30) human insulin; B29-N-(ω-carboxyheptadecanoyl)-des(B30) human insulin and B29-N-(ω-carboxyheptadecanoyl) human insulin.

Examples of GLP-1, GLP-1 analogues and GLP-1 receptor agonists are, for example, Lixisenatide (Lyxumia®), Exenatide (Exendin-4, Byetta®, Bydureon®, a 39 amino acid peptide which is produced by the salivary glands of the Gila monster), Liraglutide (Victoza®), Semaglutide, Taspoglutide, Albiglutide (Syncria®), Dulaglutide (Trulicity®), rExendin-4, CJC-1134-PC, PB-1023, TTP-054, Langlenatide/HM-11260C (Efpeglenatide), HM-15211, CM-3, GLP-1 Eligen, ORMD-0901, NN-9423, NN-9709, NN-9924, NN-9926, NN-9927, Nodexen, Viador-GLP-1, CVX-096, ZYOG-1, ZYD-1, GSK-2374697, DA-3091, MAR-701, MAR709, ZP-2929, ZP-3022, ZP-DI-70, TT-401 (Pegapamodtide), BHM-034. MOD-6030, CAM-2036, DA-15864, ARI-2651, ARI-2255, Tirzepatide (LY3298176), Bamadutide (SAR425899), Exenatide-XTEN and Glucagon-Xten.

An example of an oligonucleotide is, for example: mipomersen sodium (Kynamro®), a cholesterol-reducing antisense therapeutic for the treatment of familial hypercholesterolemia or RG012 for the treatment of Alport syndrome. Examples of DPP4 inhibitors are Linagliptin, Vildagliptin, Sitagliptin, Denagliptin, Saxagliptin, Berberine.

Examples of hormones include hypophysis hormones or hypothalamus hormones or regulatory active peptides and their antagonists, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, and Goserelin.

Examples of polysaccharides include a glucosaminoglycane, a hyaluronic acid, a heparin, a low molecular weight heparin or an ultra-low molecular weight heparin or a derivative thereof, or a sulphated polysaccharide, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium. An example of a hyaluronic acid derivative is Hylan G-F 20 (Synvisc®), a sodium hyaluronate.

The term “antibody”, as used herein, refers to an immunoglobulin molecule or an antigen-binding portion thereof. Examples of antigen-binding portions of immunoglobulin molecules include F(ab) and F(ab′)2 fragments, which retain the ability to bind antigen. The antibody can be polyclonal, monoclonal, recombinant, chimeric, de-immunized or humanized, fully human, non-human, (e.g., murine), or single chain antibody. In some embodiments, the antibody has effector function and can fix complement. In some embodiments, the antibody has reduced or no ability to bind an Fc receptor. For example, the antibody can be an isotype or subtype, an antibody fragment or mutant, which does not support binding to an Fc receptor, e.g., it has a mutagenized or deleted Fc receptor binding region. The term antibody also includes an antigen-binding molecule based on tetravalent bispecific tandem immunoglobulins (TBTI) and/or a dual variable region antibody-like binding protein having cross-over binding region orientation (CODV).

The terms “fragment” or “antibody fragment” refer to a polypeptide derived from an antibody polypeptide molecule (e.g., an antibody heavy and/or light chain polypeptide) that does not comprise a full-length antibody polypeptide, but that still comprises at least a portion of a full-length antibody polypeptide that is capable of binding to an antigen. Antibody fragments can comprise a cleaved portion of a full length antibody polypeptide, although the term is not limited to such cleaved fragments. Antibody fragments that are useful in the present specification include, for example, Fab fragments, F(ab′)2 fragments, scFv (single-chain Fv) fragments, linear antibodies, monospecific or multispecific antibody fragments such as bispecific, trispecific, tetraspecific and multispecific antibodies (e.g., diabodies, triabodies, tetrabodies), monovalent or multivalent antibody fragments such as bivalent, trivalent, tetravalent and multivalent antibodies, minibodies, chelating recombinant antibodies, tribodies or bibodies, intrabodies, nanobodies, small modular immunopharmaceuticals (SMIP), binding-domain immunoglobulin fusion proteins, camelized antibodies, and VHH containing antibodies. Additional examples of antigen-binding antibody fragments are known in the art.

The terms “Complementarity-determining region” or “CDR” refer to short polypeptide sequences within the variable region of both heavy and light chain polypeptides that are primarily responsible for mediating specific antigen recognition. The term “framework region” refers to amino acid sequences within the variable region of both heavy and light chain polypeptides that are not CDR sequences, and are primarily responsible for maintaining correct positioning of the CDR sequences to permit antigen binding. Although the framework regions themselves typically do not directly participate in antigen binding, as is known in the art, certain residues within the framework regions of certain antibodies can directly participate in antigen binding or can affect the ability of one or more amino acids in CDRs to interact with antigen. Examples of antibodies are anti PCSK-9 mAb (e.g., Alirocumab), anti IL-6 mAb (e.g., Sarilumab), and anti IL-4 mAb (e.g., Dupilumab).

Pharmaceutically acceptable salts of any API described herein are also contemplated for use in a drug or medicament in a drug delivery device. Pharmaceutically acceptable salts are for example acid addition salts and basic salts.

Those of skill in the art will understand that modifications (additions and/or removals) of various components of the APIs, formulations, apparatuses, methods, systems and embodiments described herein may be made without departing from the full scope and spirit of the present specification, which encompass such modifications and any and all equivalents thereof.

An example drug delivery device may involve a needle-based injection system as described in Table 1 of section 5.2 of ISO 11608-1:2014(E). As described in ISO 11608-1:2014(E), needle-based injection systems may be broadly distinguished into multi-dose container systems and single-dose (with partial or full evacuation) container systems. The container may be a replaceable container or an integrated non-replaceable container.

As further described in ISO 11608-1:2014(E), a multi-dose container system may involve a needle-based injection device with a replaceable container. In such a system, each container holds multiple doses, the size of which may be fixed or variable (pre-set by the user). Another multi-dose container system may involve a needle-based injection device with an integrated non-replaceable container. In such a system, each container holds multiple doses, the size of which may be fixed or variable (pre-set by the user).

As further described in ISO 11608-1:2014(E), a single-dose container system may involve a needle-based injection device with a replaceable container. In one example for such a system, each container holds a single dose, whereby the entire deliverable volume is expelled (full evacuation). In a further example, each container holds a single dose, whereby a portion of the deliverable volume is expelled (partial evacuation). As also described in ISO 11608-1:2014(E), a single-dose container system may involve a needle-based injection device with an integrated non-replaceable container. In one example for such a system, each container holds a single dose, whereby the entire deliverable volume is expelled (full evacuation). In a further example, each container holds a single dose, whereby a portion of the deliverable volume is expelled (partial evacuation).

1.-14. (canceled)

15. A computer-implemented method for performing image registration of a plurality of images of a subject, the method comprising:
receiving a first image of a subject and a second image of the subject;
performing a first image registration to register the first image and the second image;
receiving parameters of a bounding shape identifying a region of interest of the registered first image or the registered second image;
generating a first cropped image of the registered first image and a second cropped image of the registered second image based on the parameters of the bounding shape; and
performing a second image registration to register the first cropped image and the second cropped image,
wherein performing the first image registration comprises:
segmenting the first image to generate a first segmented image and segmenting the second image to generate a second segmented image;
generating a first distance map based on the first segmented image and generating a second distance map based on the second segmented image;
registering the first distance map and the second distance map; and
registering the first image and the second image based on the registration of the first distance map and the second distance map.

16. The method of claim 15, wherein the first segmented image and the second segmented image are binary images.

17. The method of claim 15, wherein the first image registration comprises a rigid transformation.

18. The method of claim 15, wherein performing the second image registration comprises performing a normalized cross correlation based on the first cropped image and the second cropped image.

19. The method of claim 18, wherein performing the second image registration further comprises using a Fast Fourier Transform (FFT) to transform the first cropped image and second cropped image from the spatial domain to the frequency domain, wherein the normalized cross correlation is performed using the first cropped image in the frequency domain and the second cropped image in the frequency domain.

20. The method of claim 15, wherein the subject is an organism and the plurality of images are plurality of images of a tissue of the organism.

21. The method of claim 20, wherein the first image is an image of a first slice of the tissue of the organism and the second image is an image of a second slice of the tissue of the organism.

22. The method of claim 20, wherein the first image registration is performed based on tissue-level morphology of the first image and the second image.

23. The method of claim 20, wherein the second image registration is performed based on cell-level morphology of the first cropped image and the second cropped image.

24. The methods of claim 15, wherein at least one of the first image or the second image is: (i) an immunohistochemistry image, or (ii) a hematoxylin and eosin stain image.

25. The method of claim 15, wherein at least one of:
the first cropped image has a higher image resolution than the first image; or
the second cropped image has a higher image resolution than the second image.

26. The method of claim 15, further comprising outputting for display the registered first cropped image and second cropped image.

27. A non-transitory computer program product comprising computer-readable code that, when executed by a computing system, causes the computing system to perform operations for performing image registration of a plurality of images of a subject, the operations comprising:
receiving a first image of a subject and a second image of the subject;
performing a first image registration to register the first image and the second image;
receiving parameters of a bounding shape identifying a region of interest of the registered first image or the registered second image;
generating a first cropped image of the registered first image and a second cropped image of the registered second image based on the parameters of the bounding shape; and
performing a second image registration to register the first cropped image and the second cropped image,
wherein performing the first image registration comprises:
segmenting the first image to generate a first segmented image and segmenting the second image to generate a second segmented image;
generating a first distance map based on the first segmented image and generating a second distance map based on the second segmented image;
registering the first distance map and the second distance map; and
registering the first image and the second image based on the registration of the first distance map and the second distance map.

28. A system comprising one or more processors and a memory, the memory storing computer readable instructions that, when executed by the one or more processors, causes the system to perform operations for performing image registration of a plurality of images of a subject, the operations comprising:
receiving a first image of a subject and a second image of the subject;
performing a first image registration to register the first image and the second image;
receiving parameters of a bounding shape identifying a region of interest of the registered first image or the registered second image;
generating a first cropped image of the registered first image and a second cropped image of the registered second image based on the parameters of the bounding shape; and
performing a second image registration to register the first cropped image and the second cropped image,
wherein performing the first image registration comprises:
segmenting the first image to generate a first segmented image and segmenting the second image to generate a second segmented image;
generating a first distance map based on the first segmented image and generating a second distance map based on the second segmented image;
registering the first distance map and the second distance map; and
registering the first image and the second image based on the registration of the first distance map and the second distance map.

29. The system of claim 28, wherein the first segmented image and the second segmented image are binary images.

30. The system of claim 28, wherein the first image registration comprises a rigid transformation.

31. The system of claim 28, wherein performing the second image registration comprises performing a normalized cross correlation based on the first cropped image and the second cropped image.

32. The system of claim 31, wherein performing the second image registration further comprises using a Fast Fourier Transform (FFT) to transform the first cropped image and second cropped image from the spatial domain to the frequency domain, wherein the normalized cross correlation is performed using the first cropped image in the frequency domain and the second cropped image in the frequency domain.

33. The system of claim 28, wherein the subject is an organism and the plurality of images are plurality of images of a tissue of the organism.

34. The system of claim 33, wherein the first image is an image of a first slice of the tissue of the organism and the second image is an image of a second slice of the tissue of the organism.
